(19) United States
(12) Patent Application Publication
(10) Pub. No.: US 2026/0221812 A1
(43) Pub. Date: Jul. 30, 2026

(54) WEARABLE ELECTRONIC DEVICE FOR WIRELESSLY RECEIVING POWER FROM EXTERNAL ELECTRONIC DEVICE AND OPERATION METHOD THEREFOR

(71) Applicant: Samsung Electronics Co., Ltd., Suwon-si (KR)

(72) Inventors: Kwangtaek WOO, Suwon-si (KR); Jaemin OH, Suwon-si (KR); Seonghun KIM, Suwon-si (KR); Hyeonbin SO, Suwon-si (KR); Jinwan AN, Suwon-si (KR); Deukkyu OH, Suwon-si (KR)

(21) Appl. No.: 19/573,635

(22) Filed: Mar. 20, 2026

Related U.S. Application Data
(63) Continuation of application No. PCT/KR2024/015066, filed on Oct. 4, 2024.

(30) Foreign Application Priority Data
Oct. 6, 2023 (KR) 10-2023-0133731
Nov. 23, 2023 (KR) 10-2023-0164909

(51) Int. Cl. H02J 50/80; A44C 9/00; H02J 7/42; H02J 7/90; H02J 50/10; H02J 50/90

(52) U.S. Cl. CPC H02J 50/80; A44C 9/0053; H02J 7/42; H02J 7/933; H02J 50/90; H02J 50/10

(57) ABSTRACT

A wearable electronic device having a ring-shaped body is provided. The wearable electronic device includes a battery, a power reception circuit, a communication circuit, memory, comprising one or more storage media, storing instructions, and one or more processors communicatively coupled to the memory, wherein the instructions, when executed by the one or more processors individually or collectively, cause the wearable electronic device to identify a power level of the battery, based on identifying that the power level is lower than a specified level, transmit power request information to an external electronic device through the communication circuit, based on transmitting the power request information, drive the wearable electronic device in a charging standby mode for wirelessly receiving power from the external electronic device, based on driving the wearable electronic device in the charging standby mode, set parameters of at least one of the power reception circuit or the communication circuit to values corresponding to the charging standby mode for wirelessly receiving power from the external electronic device, and wirelessly receive power from the external electronic device through the power reception circuit, when the wearable electronic device driven in the charging standby mode is located within a specified distance from the external electronic device.

### CROSS-REFERENCE TO RELATED APPLICATION(S)

This application is a continuation application, claiming priority under 35 U.S.C. § 365(c), of an International application No. PCT/KR2024/015066, filed on Oct. 4, 2024, which is based on and claims the benefit of a Korean patent application number 10-2023-0133731, filed on Oct. 6, 2023, in the Ministry of Intellectual Property (MOIP), and of a Korean patent application number 10-2023-0164909, filed on Nov. 23, 2023, in the Ministry of Intellectual Property (MOIP), the disclosure of each of which is incorporated by reference herein in its entirety.

### BACKGROUND

### 1. Field

The disclosure relates to a wearable electronic device for wirelessly receiving power from an external electronic device and a method for operating the same.

### 2. Description of Related Art

Along with the development of communication technology, wearable electronic devices have been miniaturized and made lightweight to the extent that they may be used without significant discomfort even when worn on a user's body. For example, wearable electronic devices such as head-mounted display (HMD) devices, smart watches (or bands), contact lens-type devices, ring-type devices, glove-type devices, shoe-type devices, or clothing-type devices have been commercialized. Since a wearable electronic device is worn directly on the body, its portability and user accessibility may be improved.

In line with recent consumer trends that prioritize design, the development of wearable electronic devices now places significant emphasis not only on their external design but also on their ease of use.

For example, a ring-shaped wearable electronic device wearable on a user's finger may be worn constantly due to its small size, allowing for the provision of various services such as managing the user's health or checking his or her health state through measurement of various biosignals.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wearable electronic device for wirelessly receiving power from an external electronic device and a method for operating the same.

Additional aspects will be set forth in part in the description which follows and, in part, will be apparent from the description, or may be learned by practice of the presented embodiments.

In accordance with an aspect of the disclosure, a wearable electronic device having a ring-shaped body is provided. The wearable electronic device includes a battery, a power reception circuit, a communication circuit, memory, comprising one or more storage media, storing instructions, and one or more processors communicatively coupled to the memory, wherein the instructions, when executed by the one or more processors individually or collectively, cause the wearable electronic device to identify a power level of the battery, based on identifying that the power level is lower than a specified level, transmit power request information to an external electronic device through the communication circuit, based on transmitting the power request information, drive the wearable electronic device in a charging standby mode for wirelessly receiving power from the external electronic device, based on driving the wearable electronic device in the charging standby mode, set parameters of at least one of the power reception circuit or the communication circuit to values corresponding to the charging standby mode for wirelessly receiving power from the external electronic device, and wirelessly receive power from the external electronic device through the power reception circuit, when the wearable electronic device driven in the charging standby mode is located within a specified distance from the external electronic device.

In accordance with another aspect of the disclosure, a method for operating a wearable electronic device having a ring-shaped body is provided. The method includes identifying a power level of a battery included in the wearable electronic device, based on identifying that the power level is lower than a specified level, transmitting power request information to an external electronic device through a communication circuit included in the wearable electronic device, based on transmitting the power request information, driving the wearable electronic device in a charging standby mode for wirelessly receiving power from the external electronic device, based on driving the wearable electronic device in the charging standby mode, setting parameters of at least one of a power reception circuit included in the wearable electronic device or the communication circuit to values corresponding to the charging standby mode for wirelessly receiving power from the external electronic device, and wirelessly receiving power from the external electronic device through the power reception circuit, when the wearable electronic device driven in the charging standby mode is located within a specified distance from the external electronic device.

In accordance with another aspect of the disclosure, one or more non-transitory computer-readable storage media storing one or more computer programs including computer-executable instructions that, when executed by one or more processors of a wearable electronic device individually or collectively, cause the electronic device to perform operations are provided. The operations include identifying a power level of a battery included in the wearable electronic device, based on identifying that the power level is lower than a specified level, transmitting power request information to an external electronic device through a communication circuit included in the wearable electronic device, based on transmitting the power request information, driving the wearable electronic device in a charging standby mode for wirelessly receiving power from the external electronic device, based on driving the wearable electronic device in the charging standby mode, setting parameters of at least one of a power reception circuit included in the wearable electronic device or the communication circuit to values corresponding to the charging standby mode for wirelessly receiving power from the external electronic device, and wirelessly receiving power from the external electronic device through the power reception circuit, when the wearable electronic device driven in the charging standby mode is located within a specified distance from the external electronic device.

In accordance with another aspect of the disclosure, an electronic device is provided. The electronic device includes a battery, a power transmission circuit, a communication circuit, a processor, and memory storing instructions. According to an embodiment, the instructions, when executed by the processor, cause the electronic device to receive power request information from a ring-shaped wearable electronic device through the communication circuit. According to an embodiment, the instructions, when executed by the processor, cause the electronic device to, based on receiving the power request information, identify a power level of the battery and whether the electronic device is located within a specified distance from the wearable electronic device. According to an embodiment, the instructions, when executed by the processor, cause the electronic device to, based on the power level of the battery being higher than a specified level and the electronic device being located within the specified distance from the wearable electronic device, wirelessly transmit power to the wearable electronic device through the power transmission circuit.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a perspective view illustrating a wearable electronic device according to an embodiment of the disclosure;

FIG. 3 is a cross-sectional view illustrating a wearable electronic device according to an embodiment of the disclosure;

FIG. 4A is a diagram illustrating a wearable electronic device and an electronic device according to an embodiment of the disclosure;

FIG. 4B is a block diagram illustrating the configurations of a wearable electronic device and an electronic device according to an embodiment of the disclosure;

FIG. 5 is a flowchart illustrating a method for wirelessly receiving power from an electronic device by a wearable electronic device according to an embodiment of the disclosure;

FIG. 6 is a flowchart illustrating a method for wirelessly transmitting power to a wearable electronic device by an electronic device according to an embodiment of the disclosure;

FIG. 7A is a diagram illustrating modes for wirelessly receiving power from an electronic device by a wearable electronic device according to an embodiment of the disclosure;

FIG. 7B is a diagram illustrating modes for wirelessly transmitting power to a wearable electronic device by an electronic device according to an embodiment of the disclosure;

FIG. 8A is a diagram illustrating an operation of wirelessly receiving power from an electronic device by a wearable electronic device according to an embodiment of the disclosure;

FIG. 8B is a diagram illustrating an operation of wirelessly receiving power from an electronic device by a wearable electronic device according to an embodiment of the disclosure;

FIG. 9A is a diagram illustrating information related to charging of a wearable electronic device, displayed on an electronic device according to an embodiment of the disclosure;

FIG. 9B is a diagram illustrating information related to charging of a wearable electronic device, displayed on an electronic device according to an embodiment of the disclosure;

FIG. 9C is a diagram illustrating information related to charging of a wearable electronic device, displayed on an electronic device according to an embodiment of the disclosure; and

FIG. 10 is a diagram illustrating a setting screen for wirelessly providing power to a wearable electronic device by an electronic device according to an embodiment.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

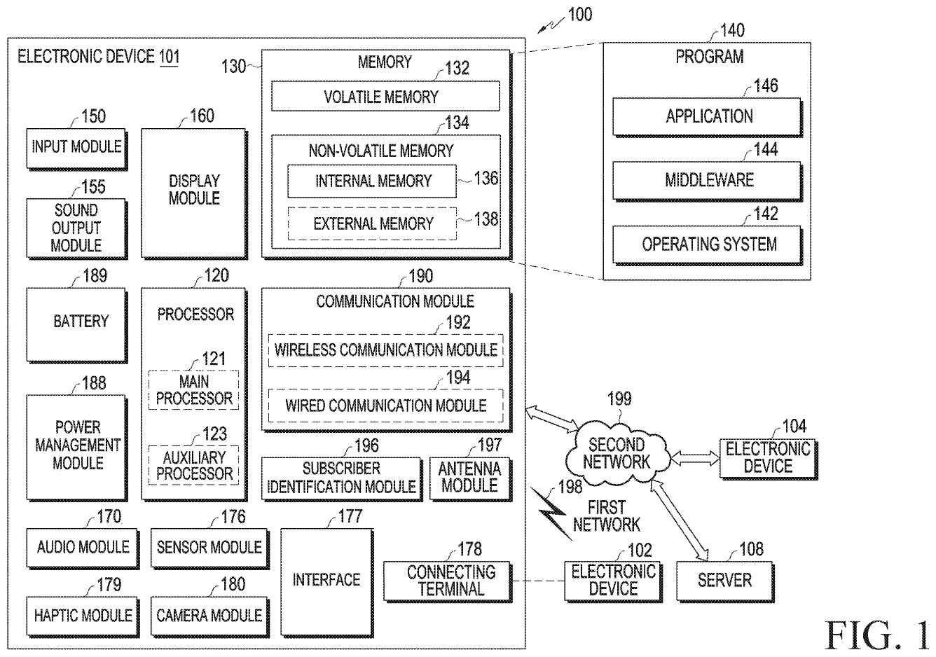

FIG. 1 is a block diagram illustrating an electronic device 101 in a network environment 100 according to an embodiment of the disclosure. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the strength of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a high definition multimedia interface (HDMI) connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a specified high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the specified high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

In the following detailed description, components that may be easily understood from a preceding embodiment may be assigned the same reference numerals in the drawings or may be omitted, and their detailed description may also be omitted. An electronic device according to an embodiment described herein may be implemented by selectively combining the configurations of different embodiments, and the configuration of an embodiment may be replaced by the configuration of another embodiment. For example, it should be noted that the disclosure is not limited to a specific drawing or embodiment.

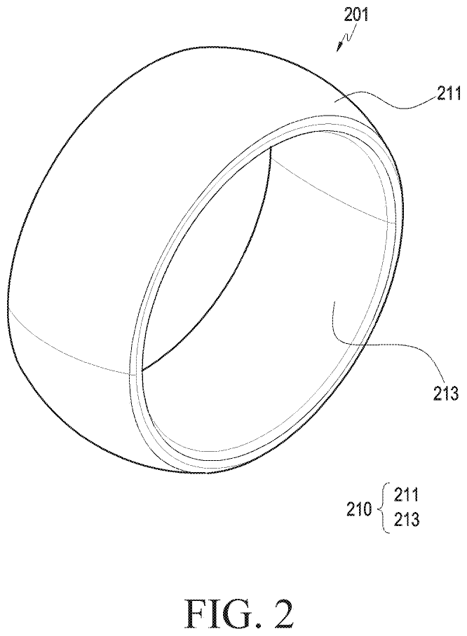

FIG. 2 is a perspective view illustrating a wearable electronic device according to an embodiment of the disclosure.

Referring to FIG. 2, a wearable electronic device 201 may include a housing 210. The housing 210 may form the overall exterior of the wearable electronic device 201.

According to an embodiment, the housing 210 may be ring-shaped. The housing 210 may include an opening configured to accommodate a user's finger. For example, the opening may be defined as a hole formed in the housing 210.

According to an embodiment, the housing 210 may include an external housing portion 211 or an internal housing portion 213. The internal housing portion 213 may be coupled to the external housing portion 211. According to an embodiment, the external housing portion 211 and the internal housing portion 213 may be manufactured separately and assembled, or they may be integrally formed.

According to an embodiment, the external housing portion 211 may include a material that may withstand external impact and/or scratches and implement design features. For example, the external housing portion 211 may include at least one of titanium, stainless steel, or ceramic. The external housing portion 211 may be color-treated or coated to implement a design.

According to an embodiment, the internal housing portion 213 may be a part that contacts the user's finger, when the user wears the wearable electronic device 201. The internal housing portion 213 may be made of a material such as a molding material for sensing, transparent plastic, or glass. For example, the internal housing portion 213 may be configured to be at least partially transparent. For example, the internal housing portion 213 may include a material that is permeable to light for measuring bio-information. At least a portion of the internal housing portion 213 may be made of substantially the same as or a similar material to the external housing portion 211. Further, at least a portion of the internal housing portion 213 may include a metallic material for bio-information measurement.

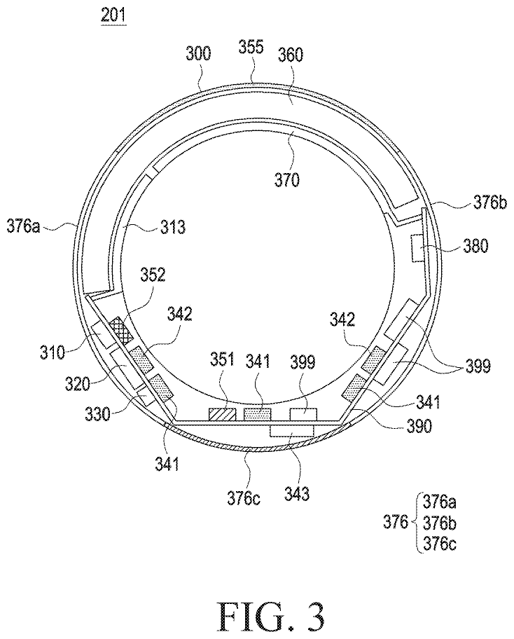

According to an embodiment, when the external housing portion 211 and the internal housing portion 213 are coupled, an internal space of the housing 210 may be provided. Various electrical/electronic components of the wearable electronic device 201 may be disposed and/or mounted in the internal space of the housing 210. For example, the housing 210 may accommodate various electrical/electronic components. FIG. 3 may be referred to for describing the internal space of the housing 210 in detail.

FIG. 3 is a cross-sectional view illustrating a wearable electronic device according to an embodiment of the disclosure.

The arrangement of components in the wearable electronic device 201 in FIG. 3 is merely illustrative. The components of the wearable electronic device 201 may be arranged in a different manner from FIG. 3.

Referring to FIG. 3, according to an embodiment, the wearable electronic device 201 may include a housing 300 (e.g., the housing 210 in FIG. 2).

According to an embodiment, the wearable electronic device 201 may include a processor (e.g., 320). For example, the processor 320 may be a microcontroller unit (MCU). Further, the processor 320 may be an application processor (AP), a supplementary processor (SP) (e.g., sensor hub), a central processor unit (CPU), a neural processor unit (NPU), a graphic processor unit (GPU), or an internet of things (IoT) processor.

According to an embodiment, the wearable electronic device 201 may include a communication module (e.g., 310).

According to an embodiment, the wearable electronic device 201 may include an antenna (e.g., 313). The antenna 313 may be an antenna for wireless communication. The antenna 313 may include a single antenna or a plurality of segmented antennas. Referring to FIG. 3, a portion of the housing 300 of the wearable electronic device 201 may be used as the antenna 313.

According to an embodiment, the wearable electronic device 201 may include memory (e.g., 330). Referring to FIG. 3, the wearable electronic device 201 may store data (e.g., sensing data and communication data) in the memory 330. Depending on implementation, the memory 330 may be integrated with the processor 320.

According to an embodiment, the wearable electronic device 201 may include a photoplethysmography (PPG) sensor (e.g., 341, 342, and 343). The PPG sensor (e.g., 341, 342, and 343) may be a sensor that illuminates biological tissues with light and receives absorbed, scattered, or reflected light. The wearable electronic device 201 may identify a biosignal using the PPG sensor (e.g., 341, 342, and 343). Referring to FIG. 3, at least one light-emitting portion 341 of the PPG sensor may emit light in various bands and include an element such as a light emitting diode (LED), a laser, or a vertical cavity surface emitting laser (VCSEL). The bands of the light-emitting portion 341 may include Green, Red, and infrared (IR). At least one light-receiving portion 342 of the PPG sensor may receive light that is reflected and/or transmitted from light irradiated by the light-emitting portion 341. A signal (e.g., light) obtained through the light-receiving portion 342 may be converted through an analog to digital converter (ADC) and stored in the memory 330 or a sensor buffer. The light-receiving portion 342 may include a photodiode (PD) or a complementary metal oxide semiconductor (CMOS). A controller 343 of the PPG sensor may be an integrated circuit (IC) or an analog front end (AFE), and control the light-emitting portion 341 and the light-receiving portion 342, process received data, and transmit it to the processor 320 or store it in the memory 330.

According to an embodiment, the wearable electronic device 201 may include an inertial sensor (e.g., 351). The inertial sensor (e.g., 351) may be a sensor that detects inertia, such as an accelerometer or a gyroscope. Referring to FIG. 3, the inertial sensor 351 may include only an accelerometer (e.g., a 3-axis sensor) or include an accelerometer and a gyroscope (e.g., a 6-axis sensor). The wearable electronic device 201 may detect (or sense) a gesture, motion, impact, posture, and action (sedentary, moving, or sports) of the wearable electronic device 201 by using the inertial sensor 351.

According to an embodiment, the wearable electronic device 201 may include a temperature sensor (e.g., 352). The temperature sensor (e.g., 352) may be a sensor that measures the temperature of biological tissues or a component. The temperature sensor (e.g., 352) may be a contact-type or a non-contact-type depending on its method. A temperature value measured through the temperature sensor (e.g., 352) may be stored in the memory 330 or transmitted to the processor 320. The wearable electronic device 201 (e.g., the processor 320) may estimate the temperature of biological tissues, estimate the temperature of the wearable electronic device 201, or recognize a surrounding condition of the wearable electronic device 201 by using the temperature sensor (e.g., 352).

According to an embodiment, the wearable electronic device 201 may include a battery (e.g., 360). The battery 360 may be a device that converts and stores chemical energy into electricity to supply power to the wearable electronic device 201. The battery 360 (e.g., a secondary battery) may be charged and discharged, and may be configured in various ways depending on its material, such as lithium-ion, mercury, or dry cells. Referring to FIG. 3, the battery 360 may include a flexible battery pack to correspond to the housing 300. The battery 360 may include a plurality of non-flexible battery packs. The battery 360 may also include a flexible battery pack and a non-flexible battery pack.

According to an embodiment, the wearable electronic device 201 may include a charging circuit (e.g., 370). The charging circuit 370 may be configured to support a wired charging (e.g., a terminal or a pogo pin) method and/or a wireless charging (e.g., WPC or NFC) method, for charging the wearable electronic device 201 (e.g., the battery 360). The wearable electronic device 201 may charge the battery 360 through the charging circuit 370.

According to an embodiment, the wearable electronic device 201 may include a power management module (e.g., 380). The power management module 380 may be a module that manages the power of the wearable electronic device 201. The wearable electronic device 201 (e.g., the processor 320) may distribute and control power appropriately to the processor 320, the memory 330, and the sensors (e.g., 341, 342, 343, 351, and 352) through the power management module (e.g., 380).

According to an embodiment, the wearable electronic device 201 may include a substrate (e.g., 390). For example, the substrate (e.g., 390) may be a flexible printed circuit board (FPCB). Referring to FIG. 3, various components such as the communication module 310, the processor 320, the memory 330, the sensors (e.g., 341, 342, 343, 351, and 352), the battery 360, and the power management module 380 may be disposed on the substrate 390. Various components disposed on the substrate 390 may be electrically connected to each other.

According to an embodiment, the wearable electronic device 201 may include a sensor module (e.g., 376). According to an embodiment, the sensor module 376 may include a touch circuit, and the touch circuit may include a touch sensor and a touch sensor IC for controlling it. The touch sensor IC may, for example, control the touch sensor to detect a touch input at a specific location on a surface of an external housing. For example, the touch sensor IC may detect a touch input by measuring a change in a signal (e.g., voltage, light intensity, resistance, or amount of charge) at the specific location on the surface. The touch sensor IC may provide information (e.g., a location, area, pressure, or time) about the detected touch input to the processor 320.

According to an embodiment, the sensor module 376 may further include a pressure sensor that may measure the intensity (pressure) of a touch.

According to an embodiment, at least a portion (e.g., the external housing portion 211 in FIG. 2) of the housing 300 of the wearable electronic device 201 may include a display module. When the wearable electronic device 201 includes a display module, the display module may include a touch circuit. Additionally, the display module may further include at least one sensor (e.g., a pressure sensor) of the sensor module 376 or a control circuit therefor. In this case, the at least one sensor or the control circuit therefor may be embedded in a portion of the display module or a portion of the touch circuit. For example, when the sensor module 376 embedded in the display module includes a pressure sensor, the pressure sensor may obtain pressure information associated with a touch input through a portion or the entire area of the housing 300 (or a display). According to an embodiment, the sensor module 376 including the touch sensor may be disposed between pixels of a pixel layer of the display, or above or below the pixel layer.

According to an embodiment, the sensor module 376 may detect a touch input on the entire area or a partial area of the curved external housing.

According to an embodiment, the sensor module 376 may detect a touch input at a first portion (or first touch area) 376a of the curved external housing and a second portion (or second touch area) 376b spaced apart from the first portion 376a by a predetermined distance. For example, the first portion 376a and the second portion 376b may correspond to positions at which the user's finger contacts adjacent fingers on both sides, when the wearable electronic device 201 is worn on the user's finger.

According to an embodiment, the sensor module 376 may include a third portion (or third touch area) 376c, which is different from the first portion 376a and the second portion 376b. In addition, a pressure sensor may be disposed in some areas 376a, 376b, and 376c to measure the intensity of a force generated by the touch. According to an embodiment, the pressure sensor may include a plurality of pressure sensors. Further, the pressure sensors may be arranged spaced apart at predetermined intervals along the curved shape of the housing, so as to detect the pressure of a touch input at a specific location on the surface of an entire area or partial area surrounding the external housing. According to one embodiment, the wearable electronic device 201 may include an audio output module, a haptic module, a light output module (e.g., a light emitting diode; LED), or other components 399.

The term ‘identify’ used herein may be replaced with detect, recognize, determine, and/or sense.

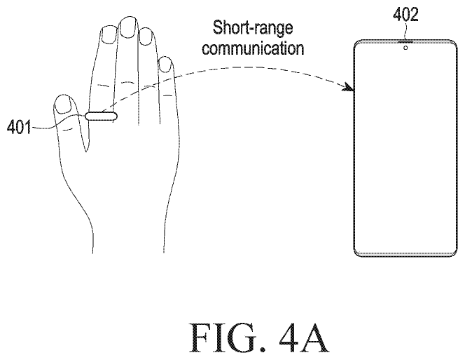

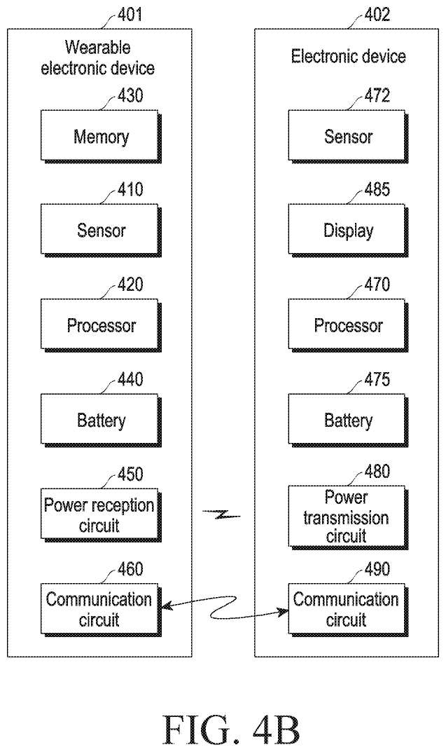

FIG. 4A is a diagram illustrating a wearable electronic device and an electronic device according to an embodiment of the disclosure.

Referring to FIG. 4A, a wearable electronic device 401 (e.g., an electronic device of FIG. 1 or the wearable electronic device 201 of FIGS. 2 and 3) according to an embodiment may wirelessly transmit and receive data to and from an external electronic device 402 (e.g., the electronic device 101 of FIG. 1). For example, the wearable electronic device 401 may transmit and receive data to and from the electronic device 402 using short-range communication (e.g., BLE communication) technology. The wearable electronic device 401 may transmit information (hereinafter, power request information) or a message for charging a battery included in the wearable electronic device 401 to the external electronic device 402 using the short-range communication technology. For example, the power request information (or power request message) may include information indicating to the external electronic device 402 that the wearable electronic device 401 is in a state requiring power transfer. Further, the power request information may include information requesting power transfer from the external electronic device 402 by the wearable electronic device 401. Depending on implementation, the power request information (or power request message) may include information indicating the power level (or power state) of the battery included in the wearable electronic device 401.

According to an embodiment, the wearable electronic device 401 may transmit state information about the wearable electronic device 401 to the external electronic device 402. For example, the state information may include information related to the battery (e.g., 360) included in the wearable electronic device 401. For example, the state information may include information about the charge level of the battery 360, the available usage time of the wearable electronic device 401 based on power stored in the battery 360, the power consumption of the wearable electronic device 401, the number of discharge cycles of the battery 360, the number of full charge cycles of the battery 360, the last charging time of the battery 360, and/or the average charging time of the battery 360. Depending on implementation, when authentication of the user for the wearable electronic device 401 is complete, the state information may include user information (e.g., the name, nickname, and/or account information of the user).

According to an embodiment, the wearable electronic device 401 may wirelessly receive power from the external electronic device 402. For example, the wearable electronic device 401 may wirelessly receive power from the external electronic device 402 using a power reception circuit 355 (e.g., an NFC-type power reception circuit and/or a power reception circuit specified by the wireless power consortium (WPC)) connected to (or included in) the charging circuit 370. For example, the power reception circuit 355 may include at least one coil (e.g., an NFC-type coil and/or a WPC-specified coil). For example, the power reception circuit 355 may be disposed in an outer portion of the housing 300. The power reception circuit 355 may be disposed so as not to be exposed to the outside of the housing 300. Depending on implementation, at least a portion of the power reception circuit 355 may be exposed to the outside of the housing 300.

According to an embodiment, when the external electronic device 402 receives power request information from the wearable electronic device 401, it may perform operations for transmitting power to the wearable electronic device 401. Further, when identifying that a specified condition for power transfer is satisfied, the external electronic device 402 may wirelessly transmit power to the wearable electronic device 401.

According to a comparative embodiment, a conventional wearable electronic device does not proactively transmit information indicating a state requiring battery charging to an external electronic device. The external electronic device is not capable of pre-identifying whether the wearable electronic device needs charging. For example, the external electronic device starts operations for charging the wearable electronic device, only when identifying that the wearable electronic device is close to or in contact with a charging area of the external electronic device. That is, since the external electronic device is not capable of pre-identifying the state of the wearable electronic device, it may not perform a charging preparatory operation in advance, even if the wearable electronic device needs charging. Due to this, the conventional wearable electronic device and the external electronic device may not start a charging operation quickly.

The wearable electronic device 401 according to an embodiment of the disclosure may perform charging preparatory operations prior to charging by performing an operation of informing the external electronic device 402 that the wearable electronic device 401 needs to be charged. Through this, the wearable electronic device 401 may start the charging operation quickly.

According to a comparative embodiment, the conventional wearable electronic device may be charged, only when a user applies a separate input or action for starting charging. For example, a ring-type wearable electronic device may start the charging operation, only when it is placed on the external electronic device after being removed by the user, and an input for starting the charging operation is identified. In this case, since an additional action of the user is required for charging the wearable electronic device, the usability of the wearable electronic device may be reduced.

The wearable electronic device 401 according to an embodiment of the disclosure may quickly start the charging operation, even if the user does not perform a separate input action while wearing the wearable electronic device 401. Through this, the usability and convenience of the wearable electronic device 401 may be increased. Further, compared to the conventional wearable electronic device, the wearable electronic device 401 according to an embodiment may start the charging operation quickly, allowing the user to charge the wearable electronic device 401 quickly while wearing it.

FIG. 4B is a block diagram illustrating components of a wearable electronic device and an electronic device according to an embodiment of the disclosure.

Referring to FIG. 4B, the wearable electronic device 401 according to an embodiment may be implemented identically or similarly to the electronic device 101 of FIG. 1 or the wearable electronic device 401 of FIGS. 2 and 3. For example, the wearable electronic device 401 may be implemented as a ring-type wearable electronic device as illustrated in FIGS. 2 and 3.

According to an embodiment, the wearable electronic device 401 may include a sensor 410 (e.g., the sensor module 176 of FIG. 1 or the sensor module 376 of FIG. 3), a processor 420 (e.g., the processor 120 of FIG. 1 or the processor 320 of FIG. 3), memory 430 (e.g., the memory 130 of FIG. 1), a battery 440 (e.g., the battery 360 of FIG. 3), a power reception circuit 450 (e.g., the charging circuit 370 of FIG. 3), and/or a communication circuit 460 (e.g., the communication module 190 of FIG. 1 or the communication module 310 of FIG. 4). According to an embodiment, the wearable electronic device 401 may not include at least one of these components or further include other components.

According to an embodiment, the processor 420 may control the overall operation of the wearable electronic device 401. The memory 430 may store data or instructions of the wearable electronic device 401. For example, the instructions stored in the memory 430 may be configured to cause the processor 420 to perform specific operations.

According to an embodiment, the processor 420 may identify the power level of the battery 440. For example, the processor 420 may identify the power level of the battery 440 at predetermined periodic intervals. The processor 420 may identify whether the power level of the battery 440 is lower than a specified level. For example, the specified level may indicate a power level (e.g., 15%) at which the battery 440 needs charging.

According to an embodiment, the processor 420 may identify whether the wearable electronic device 401 is worn by the user through the sensor 410 (e.g., a touch sensor and/or a pressure sensor). The processor 420 may identify the power level of the battery 440, based on identifying that the wearable electronic device 401 is worn by the user. For example, when the processor 420 identifies that the wearable electronic device 401 is worn by the user, it may identify the power level of the battery 440. Further, the processor 420 may identify the power level of the battery 440 according to a preset periodicity while the wearable electronic device 401 is worn by the user.

According to an embodiment, when the processor 420 identifies that the power level of the battery 440 is lower than the specified level, it may transmit power request information to the external electronic device 402 through the communication circuit 460. For example, the power request information (or power request message) may include information indicating to the external electronic device 402 that the wearable electronic device 401 is in a state requiring power transfer. Further, the power request information may include information requesting power transfer from the external electronic device 402 by the wearable electronic device 401. Depending on implementation, the power request information (or power request message) may include information indicating the current power level (or power state) of the battery 440 included in the wearable electronic device 401.

According to an embodiment, based on transmitting the power request information to the external electronic device 402, the processor 420 may drive the wearable electronic device 401 (or control the wearable electronic device 401 to enter) in a charging standby mode for wirelessly receiving power from the external electronic device 402. For example, the charging standby mode may refer to a mode in which at least one preparatory operation for wirelessly receiving power and/or charging the battery 440 using the received power is performed. For example, in the charging standby mode, the processor 420 may perform at least some specified preparatory operations among a plurality of charging preparatory operations for wirelessly receiving power and/or charging the battery 440 using the received power. For example, some preparatory operations may be specified as preparatory operations that may be performed with minimal power consumption. For example, the wearable electronic device 401 may consume no power or only minimal power in the charging standby mode. Depending on implementation, the processor 420 may perform all of the plurality of charging preparatory operations in the charging standby mode.

According to an embodiment, based on driving the wearable electronic device 401 in the charging standby mode, the processor 420 may set parameters for wirelessly receiving power from the external electronic device 402. For example, the parameters may represent setting values for wirelessly receiving power from the external electronic device 402 and/or charging the battery 440 using the received power. For example, in the charging standby mode, the processor 420 may set or adjust parameters for at least one of the power reception circuit 450 or the communication circuit 460 to values corresponding to the charging standby mode. For example, different parameter values may be set in the charging standby mode and an idle mode. For example, the processor 420 may change a specific register value related to the charging operation or hardware (e.g., the power reception circuit 450, the communication circuit 460, and/or a charging terminal) for charging.

According to an embodiment, in the charging standby mode, the processor 420 may activate the power reception circuit 450 based on the set or adjusted parameters. Through the activated power reception circuit 450, the processor 420 may perform some specified preparatory operations among a plurality of charging preparatory operations for wirelessly receiving power from the external electronic device 402. For example, the processor 420 may activate some components (e.g., some of a coil, a regulator, and a charging circuit) of the power reception circuit 450 to receive power from the external electronic device 402 more quickly. For example, when power is received based on a method specified by the WPC, the processor 420 may perform at least one of a ping phase, a configuration phase, or a negotiation phase before a power transfer phase. Alternatively, the processor 420 may perform operations for preparing at least one of the ping phase, the configuration phase, or the negotiation phase.

According to an embodiment, in the charging standby mode, the processor 420 may activate the communication circuit 460 based on the set or adjusted parameters to identify the distance between the wearable electronic device 401 and the external electronic device 402. The processor 420 may identify the distance between the wearable electronic device 401 and the external electronic device 402 based on a signal received from the external electronic device 403 through the activated communication circuit 460. Depending on implementation, the processor 420 may also activate at least one sensor in the charging standby mode to identify the distance between the wearable electronic device 401 and the external electronic device 402.

According to an embodiment, when the wearable electronic device 401 is located within a specified distance from the external electronic device 402, while being driven in the charging standby mode, the processor 420 may wirelessly receive power from the external electronic device 402 through the power reception circuit 450. For example, the specified distance may refer to a distance within which the wearable electronic device 401 may wirelessly receive power from the external electronic device 402. For example, the processor 420 may identify the distance from the external electronic device 402 based on a signal received from the external electronic device 402 through the communication circuit 460 (e.g., by identifying the strength of a BLE signal). For example, when a hand of the user wearing the wearable electronic device 401 grips the electronic device 402, the processor 420 may wirelessly receive power from the external electronic device 402 through the power reception circuit 450. Thereafter, the processor 420 may control an operation of charging the battery 440 using the received power.

According to an embodiment, the electronic device 402 (e.g., the electronic device 101 of FIG. 1) may include a processor 470 (e.g., the processor 120 of FIG. 1), a sensor 472 (e.g., the sensor module 176 of FIG. 1), a battery 475, a power transmission circuit 480, a display 485 (e.g., the display module 160 of FIG. 1), and/or a communication circuit 490 (e.g., the communication module 190 of FIG. 1). According to an embodiment, the electronic device 402 may not include at least one of these components or further include other components. For example, the electronic device 402 may further include memory for storing data or instructions of the electronic device 402. The instructions stored in the memory included in the electronic device 402 may be configured to cause the processor 470 to perform specific operations.

According to an embodiment, the processor 470 may control the overall operation of the electronic device 402.

According to an embodiment, the processor 470 may receive power request information from the wearable electronic device 401 through the communication circuit 490.

According to an embodiment, based on receiving the power request information, the processor 470 may identify whether the electronic device 402 satisfies a condition (e.g., a power level, a temperature, a distance, and/or a grip state) for charging the wearable electronic device 401. For example, the processor 470 may identify whether the power level of the battery 475 is higher than a preset level. For example, the preset level may refer to a power level at which no problem occurs in operating the electronic device 402 even if the electronic device 402 transmits power to the wearable electronic device 401. Additionally, the processor 470 may identify whether heat generated in the electronic device 402 is lower than a preset temperature.

According to an embodiment, when the power level of the battery 475 is higher than the preset level and the temperature of the electronic device 402 is lower than the preset temperature, the processor 470 may perform at least some of preparatory operations for charging the wearable electronic device 401. Depending on implementation, the processor 470 may perform at least some of the preparatory operations for charging the wearable electronic device 401, even if at least one of a power level condition or a temperature condition is not met.

According to an embodiment, when identifying that the power level and temperature of the battery 475 satisfy the specified conditions, the processor 470 may identify whether the electronic device 402 is located within a specified distance from the wearable electronic device 401. For example, the specified distance may refer to a distance at which the electronic device 402 may wirelessly transmit power to the wearable electronic device 401. For example, the processor 470 may identify the distance from the wearable electronic device 402 based on a signal received from the wearable electronic device 401 through the communication circuit 490 (e.g., by identifying the strength of a BLE signal).

According to an embodiment, when the electronic device 402 is located within the specified distance from the wearable electronic device 401, the processor 470 may wirelessly transmit power to the wearable electronic device 401 through the power transmission circuit 480 (e.g., an NFC-type power transmission/reception circuit or a power transmission/reception circuit operating in a method specified by the WPC).

According to an embodiment, the processor 470 may identify whether the user has gripped the electronic device 402 with a hand wearing the wearable electronic device 401 through the sensor 472 (e.g., a grip sensor, a touch sensor, and/or a pressure sensor).

According to an embodiment, when identifying that the user has gripped the electronic device 402 with the hand wearing the wearable electronic device 401, the processor 470 may identify that the electronic device 402 is located within the specified distance from the wearable electronic device 401.

According to an embodiment, the processor 470 may display information related to the charging of the wearable electronic device 401 through the display 485. For example, the processor 470 may display information indicating whether charging is in progress and/or information indicating the power level of the battery of the wearable electronic device 401. Alternatively, the processor 470 may display guidance information inducing the charging of the wearable electronic device 401 (e.g., information inducing the user to grip the electronic device 402 with the hand wearing the wearable electronic device 401). For example, when the processor 470 receives power request information from the wearable electronic device 401, it may display guidance information inducing the charging of the wearable electronic device 401.

According to the method described above, the processor 420 may quickly start the charging operation of the wearable electronic device 401, even if the user does not perform a separate input action while wearing the wearable electronic device 401. Through this, the usability and convenience of the wearable electronic device 401 may be increased.

The operations of the wearable electronic device 401 described below with reference to the following drawings may be performed by the processor 420. However, for convenience of description, the operations performed by the processor 420 will be described as being performed by the wearable electronic device 401.

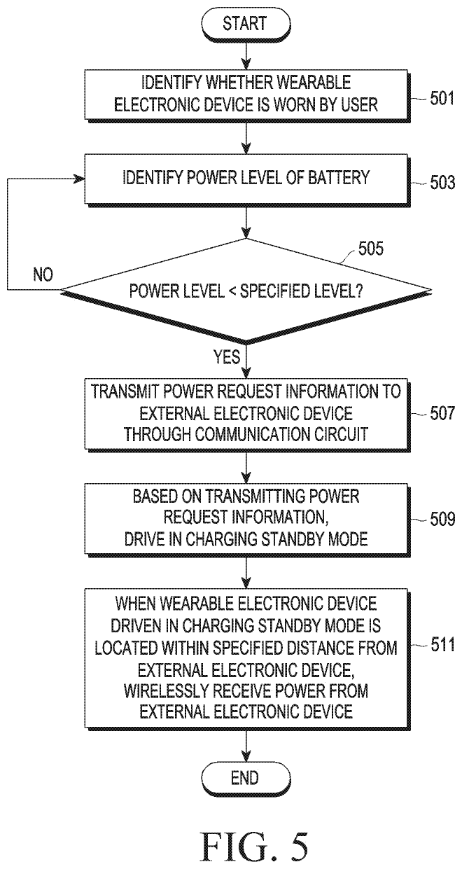

FIG. 5 is a flowchart illustrating a method for wirelessly receiving power from an external electronic device by a wearable electronic device according to an embodiment of the disclosure.

In the following embodiment, the operations may be performed sequentially, but not necessarily. For example, the order of the operations may be changed, and at least two operations may be performed in parallel. Depending on implementation, a specific operation may be omitted.

Referring to FIG. 5, according to an embodiment, in operation 501, a wearable electronic device (e.g., the wearable electronic device 401 of FIG. 4) may identify whether it is worn by a user (e.g., the user's finger), using a sensor (e.g., the sensor 410 of FIG. 4).

According to an embodiment, in operation 503, the wearable electronic device 401 may identify the power level of the battery (e.g., the battery 440 of FIG. 4). For example, when identifying that the wearable electronic device 401 is worn by the user (e.g., the user's finger), the wearable electronic device 401 may identify the power level of the battery 440.

According to an embodiment, in operation 505, the wearable electronic device 401 may identify whether the power level of the battery 440 is lower than a specified level.

According to an embodiment, when identifying that the power level of the battery 440 is lower than the specified level (yes in operation 505), the wearable electronic device 401 may transmit power request information to the external electronic device 402 through the communication circuit (e.g., communication circuit 460 of FIG. 4) in operation 507. According to an embodiment, when identifying that the power level of the battery 440 is not lower than the specified level (no in operation 505), the wearable electronic device 401 may not transmit the power request information to the external electronic device 402.

Depending on implementation, some of operations 505 to 507 may be omitted or modified. For example, the wearable electronic device 401 may transmit the power request information to the external electronic device 402 without considering the power level of the battery 440. Alternatively, when identifying that the power of the battery 440 is not full, the wearable electronic device 401 may transmit the power request information to the external electronic device 402.

According to an embodiment, in operation 509, the wearable electronic device 401 may drive in (or enter) the charging standby mode, based on transmitting the power request information. For example, in the charging standby mode, the wearable electronic device 401 may perform at least some of charging preparatory operations for wirelessly receiving power from the external electronic device 402. Further, in the charging standby mode, the wearable electronic device 401 may determine and apply parameters (or setting values) for wirelessly receiving power from the external electronic device 402. For example, the wearable electronic device 401 may change or adjust parameters (or setting values) to better wirelessly receive power. Alternatively, the wearable electronic device 401 may pre-activate specific components (e.g., at least some of a power reception circuit, a communication circuit, or a charging circuit) that wirelessly receive power.

According to an embodiment, in the charging standby mode, the wearable electronic device 401 may activate the power reception circuit 450 based on the changed or adjusted parameters. Through the activated power reception circuit 450, the wearable electronic device 401 may perform some specified preparatory operations among a plurality of charging preparatory operations for wirelessly receiving power from the external electronic device 402. For example, the wearable electronic device 401 may activate some components (e.g., some of a coil, a regulator, and a charging circuit) of the power reception circuit 450 to receive power from the external electronic device 402 more quickly.

According to an embodiment, in the charging standby mode, the wearable electronic device 401 may activate the communication circuit 460 based on the changed or adjusted parameters to identify the distance between the wearable electronic device 401 and the external electronic device 402. The wearable electronic device 401 may identify the distance between the wearable electronic device 401 and the external electronic device 402 based on a signal received from the external electronic device 403 through the activated communication circuit 460. Depending on implementation, the wearable electronic device 401 may also activate at least one sensor in the charging standby mode to identify the distance from the external electronic device 402.

According to an embodiment, in operation 511, when the wearable electronic device 401 driven in the charging standby mode is located within a specified distance from the external electronic device 402, the wearable electronic device 401 may wirelessly receive power from the external electronic device 402. For example, when the hand of the user wearing the wearable electronic device 401 grips the external electronic device 402, the wearable electronic device 401 may wirelessly receive power from the external electronic device 402.

According to an embodiment, the wearable electronic device 401 may charge the battery 440 using the received power.

According to an embodiment, when the wearable electronic device 401 is located outside the specified distance from the external electronic device 402 during charging, it may stop the charging operation. Alternatively, when a condition (e.g., a temperature condition and a battery power level condition) related to a state of the external electronic device 402 changes during charging, the wearable electronic device 401 may stop the charging operation. At this time, the wearable electronic device 401 may be driven in the charging standby mode again or be driven in the idle mode. For example, the idle mode may refer to a mode (or state) in which charging settings are released. The wearable electronic device 401 may stop the charging operation by identifying that an interrupt for stopping the charging operation has occurred internally.

According to an embodiment, when the wearable electronic device 401 is located within the specified distance from the external electronic device 402 again after stopping the charging operation, it may resume the charging operation. Alternatively, when the condition (e.g., the temperature condition and the battery power level condition) related to the state of the external electronic device 402 changes again after stopping the charging operation, the wearable electronic device 401 may resume the charging operation.

According to an embodiment, when the charging of the battery 440 is completed, the wearable electronic device 401 may stop the charging operation. At this time, the wearable electronic device 401 may be driven in the idle mode. Further, the wearable electronic device 401 may transmit information (or a message) indicating that the charging of the battery 440 is complete to the external electronic device 402.

The operations of the electronic device 402 described with reference to the following drawing may be performed by the processor 470. However, for convenience of description, the operations performed by the processor 470 will be described as being performed by the electronic device 402.

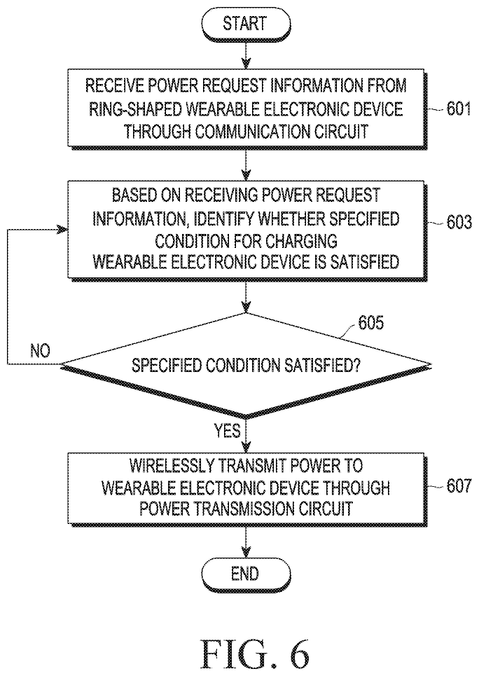

FIG. 6 is a flowchart illustrating a method for wirelessly transmitting power to a wearable electronic device by an electronic device according to an embodiment of the disclosure.

In the following embodiment, the operations may be performed sequentially, but not necessarily. For example, the order of the operations may be changed, and at least two operations may be performed in parallel. Depending on implementation, a specific operation may be omitted.

Referring to FIG. 6, according to an embodiment, in operation 601, an external electronic device (hereinafter, an electronic device) (e.g., the electronic device 402 of FIG. 4) may receive power request information from a ring-type wearable electronic device (e.g., the wearable electronic device 401 of FIG. 4) through a communication circuit (e.g., the communication circuit 490 of FIG. 4).

According to an embodiment, in operation 603, based on receiving the power request information, the electronic device 402 may identify whether its state satisfies a specified condition for charging the wearable electronic device 401. For example, the electronic device 402 may identify whether the temperature of the electronic device 402, the power level of the battery (e.g., the battery 475 of FIG. 4), and/or the distance from the wearable electronic device 401 satisfy the specified condition.

According to an embodiment, when identifying that the state of the electronic device 402 satisfies the specified condition, the electronic device 402 may identify whether a wireless power transfer function (e.g., a wireless charging sharing mode) is activated (e.g., the function is on). For example, when the function is not activated, the electronic device 401 may activate the wireless power transfer function (e.g., turn the function on). According to an embodiment, when identifying that the state of the electronic device 402 does not satisfy the specified condition, the electronic device 402 may identify whether the wireless power transfer function (e.g., the wireless charging sharing mode) is deactivated (e.g., the function is off). For example, when the function is not deactivated, the electronic device 401 may deactivate the wireless power transfer function (e.g., turn the function off).

According to an embodiment, when identifying that the state of the electronic device 402 satisfies the specified condition (yes in operation 605), the electronic device 402 may wirelessly transmit power to the wearable electronic device 401 through the power transmission circuit (e.g., the power transmission circuit 480 of FIG. 4) in operation 607. The electronic device 401 may display information related to charging of the wearable electronic device 401 (e.g., information indicating charging in progress or the battery level of the wearable electronic device 401) on the display (e.g., the display 485 of FIG. 4).

According to an embodiment, when identifying that the state of the electronic device 402 does not satisfy the specified condition (no in operation 605), the electronic device 402 may not wirelessly transmit power to the wearable electronic device 401. For example, when identifying that the state of the electronic device 402 does not satisfy the specified condition (no in operation 605), the electronic device 402 may continuously identify whether the state of the electronic device 402 satisfies the specified condition.

Depending on implementation, even if a condition related to the power level of the battery 475 and/or the temperature of the electronic device 402 is not satisfied, when the wearable electronic device 401 is located within a specified distance from the electronic device 402, the electronic device 402 may wirelessly transmit power to the wearable electronic device 401. For example, when identifying that the user has gripped the electronic device 402 with a hand wearing the wearable electronic device 401, the electronic device 201 may wirelessly transmit power to the wearable electronic device 401.

According to an embodiment, when the wearable electronic device 401 is located outside the specified distance during charging, the electronic device 402 may stop the charging operation (or the power transmission operation). Alternatively, when the condition (e.g., a temperature condition or a battery power level condition) related to the state of the electronic device 401 changes during charging, the electronic device 402 may stop the charging operation (or the power transmission operation).

According to an embodiment, when the wearable electronic device 401 is located within the specified distance from the electronic device 402 again after stopping the charging operation, the electronic device 402 may resume the charging operation. Alternatively, when the condition (e.g., the temperature condition and the battery power level condition) related to the state of the electronic device 402 changes again after stopping the charging operation, the electronic device 402 may resume the charging operation.

According to an embodiment, when the charging of the battery 440 of the wearable electronic device 401 is complete, the electronic device 401 may stop the charging operation (e.g., the power transmission operation). The electronic device 402 may display information indicating that the charging of the wearable electronic device 401 is complete on the display 485.

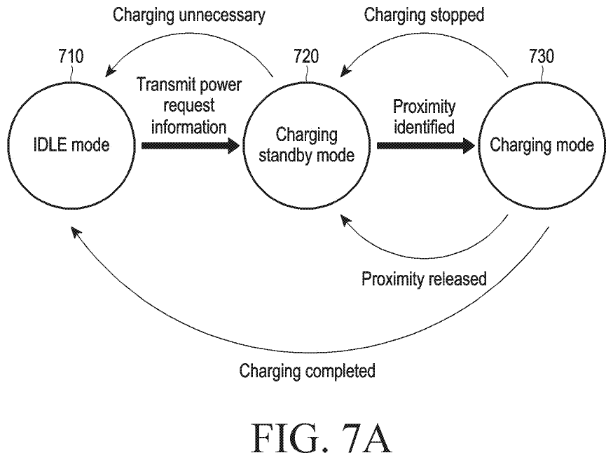

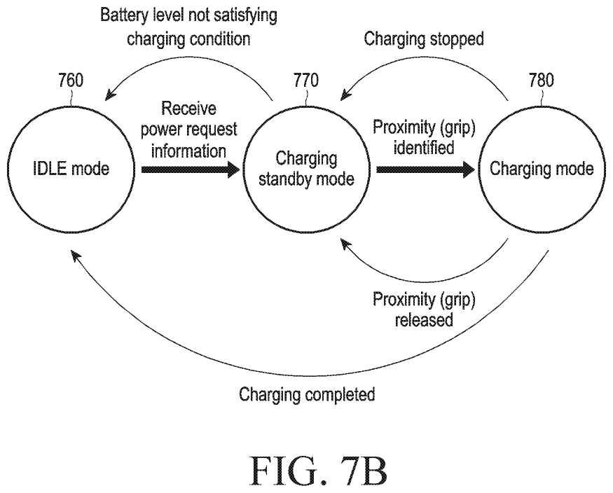

FIG. 7A is a diagram illustrating modes for wirelessly receiving power from an electronic device by a wearable electronic device according to an embodiment of the disclosure.

Referring to FIG. 7A, according to an embodiment, the wearable electronic device (e.g., the wearable electronic device 401 of FIG. 4) may be driven in one of an idle mode 710, a charging standby mode 720, and a charging mode 730. For example, the idle mode may refer to a mode (or state) in which settings for charging are released. The charging standby mode 720 may refer to a mode (or state) in which at least one preparatory operation for wirelessly receiving power and/or charging the battery (e.g., the battery 440 of FIG. 4) using the received power is performed. The charging mode 730 may refer to a mode (or state) in which power is received wirelessly from an external electronic device (e.g., the electronic device 402 of FIG. 4) and the battery 440 is charged using the received power.

According to an embodiment, the wearable electronic device 401 may be driven in the idle mode 710. The wearable electronic device 401 may identify or monitor the power level of the battery 440 in the idle mode 710.

According to an embodiment, when identifying that the battery 440 needs charging while the wearable electronic device 401 operates in the idle mode 710, the wearable electronic device 401 may transmit power request information to the external electronic device 402. Based on transmitting the power request information, the wearable electronic device 401 may enter and be driven in the charging standby mode 720. Thereafter, when the wearable electronic device 401 determines that charging the battery 440 is unnecessary, it may re-enter the idle mode 710.

According to an embodiment, when the wearable electronic device 401 does not enter the charging mode 730 for a specified time (e.g., 1 minute) after entering the charging standby mode 720, it may re-enter the idle mode 710. Through this, the wearable electronic device 401 may be prevented from waiting indefinitely in the charging standby mode 720.

According to an embodiment, when the wearable electronic device 401 re-enters the idle mode 710 from the charging standby mode 720 due to the expiration of the specified time, the wearable electronic device 401 may identify or determine whether the battery 440 still needs charging. When identifying that the battery 440 still needs charging, the wearable electronic device 401 may transmit power request information to the electronic device 402. At this time, the wearable electronic device 401 may re-enter the charging standby mode 720.

According to an embodiment, when the wearable electronic device 401 approaches the electronic device 402 within a specified distance while operating in the charging standby mode 720, it may receive power from the external electronic device 402. At this time, the wearable electronic device 401 may enter and be driven in the charging mode 730. Thereafter, when the proximity to the electronic device 402 is released, the wearable electronic device 401 may re-enter the charging standby mode 720. Alternatively, when a specified condition for power transmission from the electronic device 402 is not satisfied, the charging operation may be stopped. At this time, the wearable electronic device 401 may re-enter the charging standby mode 720.

According to an embodiment, when the charging of the battery 440 is complete, the wearable electronic device 401 may enter and be driven in the idle mode 710.

In the method described above, the wearable electronic device 401 may actively change a mode to quickly charge the battery 440. Through this, the wearable electronic device 401 may quickly and conveniently receive power from the external electronic device 402.

FIG. 7B is a diagram illustrating modes for wirelessly transmitting power to a wearable electronic device by an electronic device according to an embodiment of the disclosure.

Referring to FIG. 7B, according to an embodiment, the electronic device (e.g., the electronic device 402 of FIG. 4) may be driven in one of an idle mode 760, a charging standby mode 770, and a charging mode 780. For example, the idle mode may refer to a mode (or state) in which settings for charging the wearable electronic device (e.g., the wearable electronic device 401 of FIG. 4) (or settings for power transmission) are released. The charging standby mode 770 may refer to a mode (or state) in which at least one preparatory operation for wirelessly transmitting power is performed. The charging mode 780 may refer to a mode (or state) in which power is transmitted wirelessly to the wearable electronic device 401.

According to an embodiment, the electronic device 402 may be driven in the idle mode 760. The electronic device 402 may receive power request information from the wearable electronic device 401 in the idle mode 760.

According to an embodiment, based on receiving the power request information while operating in the idle mode 760, the electronic device 402 may enter and be driven in the charging standby mode 770. Depending on implementation, when a specific condition (e.g., a power level condition of the battery 475 or a temperature condition) is satisfied, the electronic device 402 may enter the charging standby mode 770. Thereafter, when the specific condition (e.g., the power level of the battery 475 for charging) is not satisfied, the electronic device 402 may re-enter the idle mode 760.

According to an embodiment, when the wearable electronic device 401 approaches the electronic device 402 within a specified distance (or when the user's hand wearing the wearable electronic device 401 grips the electronic device 402) while operating in the charging standby mode 770, it may transmit power to the wearable electronic device 401. At this time, the electronic device 402 may enter and be driven in the charging mode 780. Thereafter, when the proximity to the wearable electronic device 401 is released, the electronic device 402 may re-enter the charging standby mode 770. Alternatively, when the specified condition for power transmission from the electronic device 402 is not satisfied, the electronic device 402 may stop the charging operation. At this time, the electronic device 402 may re-enter the charging standby mode 770 or the idle mode 760.

According to an embodiment, when the charging of the battery 440 of the wearable electronic device 401 is complete, the electronic device 402 may enter and be driven in the idle mode 760.

As in the method described above, the electronic device 402 may actively change a mode to quickly charge the battery 440 of the wearable electronic device 401. Through this, the electronic device 402 may quickly and conveniently transmit power to the wearable electronic device 401.

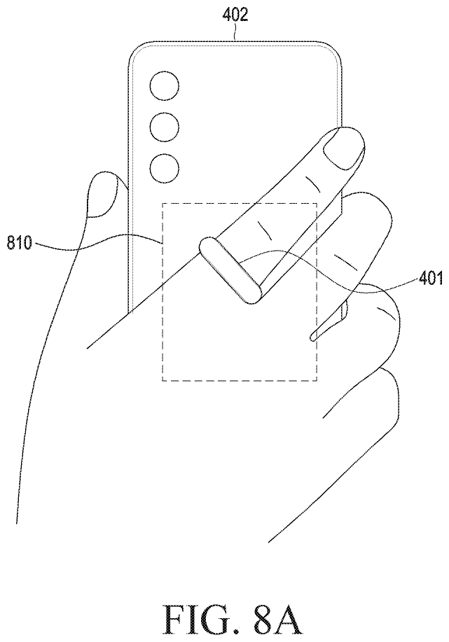

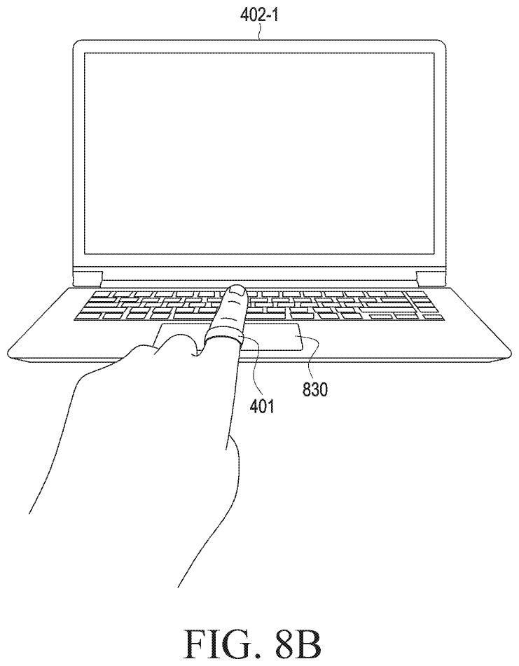

FIG. 8A is a diagram illustrating an operation of wirelessly receiving power from an electronic device by a wearable electronic device according to an embodiment of the disclosure.

Referring to FIG. 8A, according to an embodiment, when the electronic device 402 (e.g., a smartphone or a wireless charging pad area 810) is gripped by the hand of the user wearing the wearable electronic device 401, the electronic device 402 may wirelessly transmit power to the wearable electronic device 401. The wearable electronic device 401 may charge the battery (e.g., the battery 440 of FIG. 4) using the power received from the external electronic device 402.

According to an embodiment, the electronic device 402 may identify whether it is gripped by the user's hand through the sensor (e.g., the sensor 472 of FIG. 4). For example, the sensor may include a grip sensor, a touch sensor, and/or a pressure sensor. Additionally, the electronic device 402 may identify whether the wearable electronic device 401 is located within a specified distance through the communication circuit (e.g., the communication circuit 490 of FIG. 4). Depending on implementation, the electronic device 402 may also use the power transmission circuit (e.g., the power transmission circuit 450 of FIG. 4 or an NFC circuit) to identify whether the wearable electronic device 401 is located within the specified distance. When identifying that the electronic device 402 is gripped by the user's hand and the wearable electronic device 401 is located within the specified distance, the electronic device 402 may identify that it is gripped by the hand of the user wearing the wearable electronic device 401.

According to an embodiment, an electronic device 402-1 may wirelessly transmit power to the wearable electronic device 401 worn on the user's hand that grips the wireless charging pad area 810.

Through the method described above, the wearable electronic device 401 may charge the battery 440 while the user wears the wearable electronic device 401. Accordingly, the usability and convenience of the wearable electronic device 401 may be increased.

FIG. 8B is a diagram illustrating an operation of wirelessly receiving power from an electronic device by a wearable electronic device according to an embodiment of the disclosure.

Referring to FIG. 8B, according to an embodiment, when the user's hand wearing the wearable electronic device 401 is placed on a wireless charging area (e.g., a touchpad 830 of a laptop) of the electronic device 402-1 (e.g., the laptop), the electronic device 402-1 may wirelessly transmit power to the wearable electronic device 401. For example, the electronic device 402-1 may perform substantially the same function as the electronic device 402 of FIG. 8A. The wearable electronic device 401 may charge the battery (e.g., the battery 440 of FIG. 4) using power received from the external electronic device 402-1.

According to an embodiment, the electronic device 402-1 may identify whether the user's hand is placed on the electronic device 402-1 (e.g., the touchpad 830 of the laptop) through a sensor (e.g., the sensor 472 of FIG. 4). Additionally, the electronic device 402-1 may identify whether the wearable electronic device 401 is located within a specified distance through a communication circuit (e.g., the communication circuit 490 of FIG. 4). When identifying that the user's hand is placed on the electronic device 402-1 (e.g., the touchpad 830 of the laptop) and the wearable electronic device 401 is located within the specified distance, the electronic device 402-1 may identify that the user's hand wearing the wearable electronic device 401 is placed on the electronic device 402-1 (e.g., the touchpad 830 of the laptop).

According to an embodiment, the electronic device 402-1 may wirelessly transmit power to the wearable electronic device 401 placed on the touchpad 830 or the wireless charging area.

Through the method described above, the wearable electronic device 401 may charge the battery 440, while the user wears the wearable electronic device 401. Accordingly, the usability and convenience of the wearable electronic device 401 may be increased.

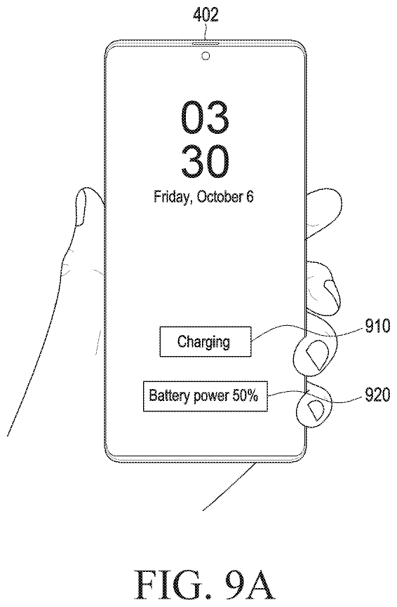

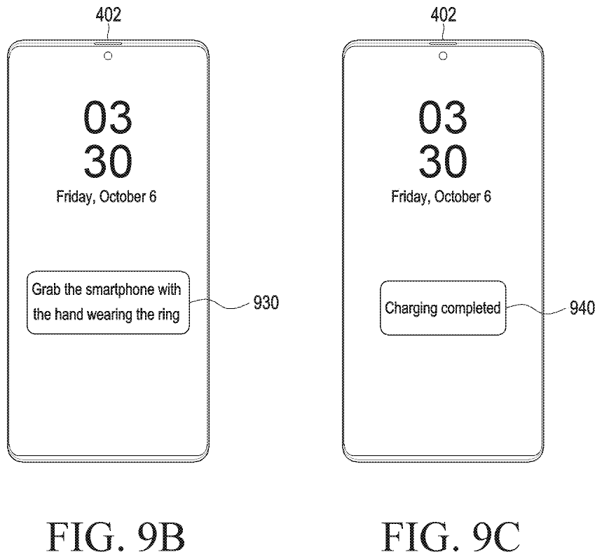

FIG. 9A is a diagram illustrating information related to charging of a wearable electronic device, displayed on an electronic device, according to an embodiment of the disclosure.

Referring to FIG. 9A, according to an embodiment, while charging the wearable electronic device 401, the electronic device (e.g., the electronic device 402 of FIG. 4) may obtain information about the remaining charge level of the battery 440 of the wearable electronic device 401 from the wearable electronic device 401. The electronic device 402 may display information 910 indicating the charging state and information 920 about the remaining charge level of the battery 440 of the wearable electronic device 401 on the display (e.g., the display 485 of FIG. 4). Further, the electronic device 401 may display information about a target device for charging (e.g., the wearable electronic device 401). Depending on implementation, the electronic device 401 may further display information about a time required to fully charge the battery 440.

FIG. 9B is a diagram illustrating information related to charging of a wearable electronic device, displayed on an electronic device, according to an embodiment of the disclosure.

Referring to FIG. 9B, according to an embodiment, when the electronic device (e.g., the electronic device 401 of FIG. 4) receives power request information from the wearable electronic device (e.g., the wearable electronic device 401 of FIG. 4), it may display guidance information 930 that induces the charging of the wearable electronic device 401 on the display (e.g., the display 485 of FIG. 4). For example, the guidance information 930 may include information that induces the user to grip the electronic device 402 with the hand wearing the wearable electronic device 401.

According to another embodiment, even when it is identified that the user is gripping the electronic device 402 with the hand not wearing the wearable electronic device 401, the electronic device 402 may display the guidance information 930 that induces the charging of the wearable electronic device 401 on the display 485. For example, when the electronic device 402 detects that the user's hand is gripping it through the sensor (e.g., the sensor 472 of FIG. 4) and identifies that the wearable electronic device 401 is located at a distance greater than a specified distance from the electronic device 402, it may display the guidance information 930.

According to another embodiment, even when the proximity of the wearable electronic device 401 is released while charging the wearable electronic device 401, the electronic device 402 may display the guidance information 930 that induces the charging of the wearable electronic device 401 on the display 485. For example, when the electronic device 402 identifies that the wearable electronic device 401 is located at a distance greater than the specified distance from the electronic device 402 during charging, it may stop the charging operation and display the guidance information 930.

FIG. 9C is a diagram illustrating information related to charging of a wearable electronic device, displayed on an electronic device, according to an embodiment of the disclosure.

Referring to FIG. 9C, according to an embodiment, when the charging of the wearable electronic device (e.g., wearable electronic device 401 of FIG. 4 is complete, the electronic device (e.g., the electronic device 402 of FIG. 4) may obtain information indicating charging completion from the wearable electronic device 401. The electronic device 401 may display information 940 indicating charging completion on the display (e.g., the display 485 of FIG. 4).

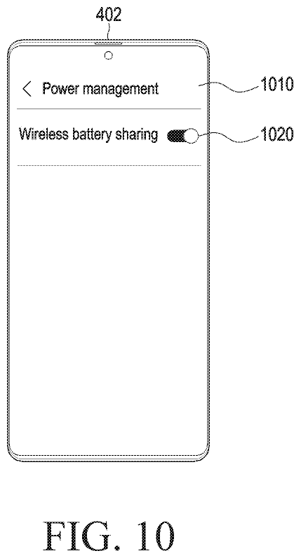

FIG. 10 is a diagram illustrating a setting screen for wirelessly providing power to a wearable electronic device by an electronic device according to an embodiment of the disclosure.

Referring to FIG. 10, according to an embodiment, when the wearable electronic device (e.g., the wearable electronic device 401 of FIG. 4) approaches the electronic device 401 or when the user's finger wearing the wearable electronic device 401 grips the electronic device 401, the electronic device (e.g., electronic device 402 of FIG. 4) may activate or deactivate an automatic power transfer function. Alternatively, when the electronic device 402 receives power request information from the wearable electronic device 401, it may activate or deactivate the automatic power transfer function.

According to an embodiment, the electronic device 402 may display a setting window 1010 for setting the corresponding function on the display (e.g., the display 485 of FIG. 4). The electronic device 402 may activate or deactivate the function based on a user input to an activation object 1020. According to another embodiment, when the wearable electronic device 401 is pre-registered to the electronic device 401, the electronic device 401 may automatically activate the function. For example, when the display of the electronic device 402 is deactivated (e.g., display off and/or screen lock), and the wearable electronic device 401 is identified as pre-registered to the electronic device 401, the electronic device 402 may transmit power to the wearable electronic device 401 without activating the display (e.g., display on and/or screen unlock) in response to the power request information received from the wearable electronic device 401. For example, when the wearable electronic device 401 pre-registered to the electronic device 402 requests power transmission from the electronic device 402, the electronic device 402 may skip an authentication procedure for unlocking the screen of the electronic device 402 (e.g., replacing the authentication operation with the operation of receiving power request information).

According to the method described above, the electronic device 402 may quickly start the charging operation of the wearable electronic device 401, even if the user does not perform a separate input action while wearing the wearable electronic device 401. Through this, the usability and convenience of the wearable electronic device 401 may be increased.

According to an embodiment, the ring-shaped wearable electronic device 201 or 401 may include the battery 440, the power reception circuit 450, the communication circuit 460, the processor 420, and the memory 430 storing instructions. According to an embodiment, the instructions, when executed by the processor, may cause the wearable electronic device to identify a power level of the battery. According to an embodiment, the instructions, when executed by the processor, may cause the electronic device to, based on identifying that the power level is lower than a specified level, transmit power request information to an external electronic device 402 through the communication circuit. According to an embodiment, the instructions, when executed by the processor, may cause the electronic device to, based on transmitting the power request information, drive the wearable electronic device in a charging standby mode for wirelessly receiving power from the external electronic device. According to an embodiment, the instructions, when executed by the processor, may cause the electronic device to, based on driving the wearable electronic device in the charging standby mode, set parameters of at least one of the power reception circuit or the communication circuit to values corresponding to the charging standby mode for wirelessly receiving power from the external electronic device. According to an embodiment, the instructions, when executed by the processor, may cause the electronic device to wirelessly receive power from the external electronic device through the power reception circuit, when the wearable electronic device driven in the charging standby mode is located within a specified distance from the external electronic device.

According to an embodiment, the instructions, when executed by the processor, may cause the electronic device to wirelessly receive power from the external electronic device through the power reception circuit, when the external electronic device is gripped by a hand of a user wearing the wearable electronic device.

According to an embodiment, the instructions, when executed by the processor, may cause the electronic device to identify whether the wearable electronic device is worn by the user through the sensor 410 included in the wearable electronic device. According to an embodiment, the instructions, when executed by the processor, may cause the electronic device to, based on identifying that the wearable electronic device is worn by the user, identify the power level of the battery.

According to an embodiment, the instructions, when executed by the processor, may cause the electronic device to change a driving mode of the wearable electronic device from an idle mode to the charging standby mode, based on transmitting the power request information.

According to an embodiment, the instructions, when executed by the processor, may cause the electronic device to drive in the idle mode, when battery charging is complete.

According to an embodiment, the instructions, when executed by the processor, may cause the electronic device to stop the reception of power from the external electronic device, when the wearable electronic device is located outside the specified distance from the external electronic device while wirelessly receiving power from the external electronic device.

According to an embodiment, the instructions, when executed by the processor, may cause the electronic device to drive in the charging standby mode, based on stopping the reception of power.

According to an embodiment, the instructions, when executed by the processor, may cause the electronic device to activate the power reception circuit based on the parameters, in the charging standby mode. According to an embodiment, the instructions, when executed by the processor, may cause the electronic device to perform, through the activated power reception circuit, a specified preparatory operation among a plurality of charging preparatory operations for wirelessly receiving power from the external electronic device in the charging standby mode.

According to an embodiment, the instructions, when executed by the processor, may cause the electronic device to activate the communication circuit based on the parameters to identify a distance from the external electronic device, in the charging standby mode. According to an embodiment, the instructions, when executed by the processor, may cause the electronic device to identify, through the activated communication circuit, the distance from the external electronic device based on a signal received from the external electronic device in the charging standby mode.

According to an embodiment, a method for operating the ring-shaped wearable electronic device 201 or 401 may include identifying a power level of a battery 440 included in the wearable electronic device. According to an embodiment, the method for operating the ring-shaped wearable electronic device may include, based on identifying that the power level is lower than a specified level, transmitting power request information to the external electronic device 402 through the communication circuit 460 included in the wearable electronic device. According to an embodiment, the method for operating the ring-shaped wearable electronic device may include, based on transmitting the power request information, driving the wearable electronic device in a charging standby mode for wirelessly receiving power from the external electronic device. According to an embodiment, the method for operating the ring-shaped wearable electronic device may include, based on driving the wearable electronic device in the charging standby mode, setting parameters of at least one of a power reception circuit 450 included in the wearable electronic device or the communication circuit to values corresponding to the charging standby mode for wirelessly receiving power from the external electronic device. According to an embodiment, the method for operating the ring-shaped wearable electronic device may include wirelessly receiving power from the external electronic device through the power reception circuit, when the wearable electronic device driven in the charging standby mode is located within a specified distance from the external electronic device.

According to an embodiment, wirelessly receiving power from the external electronic device may include wirelessly receiving power from the external electronic device through the power reception circuit, when the external electronic device is gripped by a hand of a user wearing the wearable electronic device.

According to an embodiment, identifying the power level of the battery may include identifying whether the wearable electronic device is worn by the user through a sensor 410 included in the wearable electronic device. According to an embodiment, identifying the power level of the battery may include, based on identifying that the wearable electronic device is worn by the user, identifying the power level of the battery.

According to an embodiment, identifying the power level of the battery may include driving the wearable electronic device in the charging standby mode may include changing a driving mode of the wearable electronic device from an idle mode to the charging standby mode, based on transmitting the power request information.

According to an embodiment, the method for operating the wearable electronic device may further include driving the wearable electronic device in the idle mode, when battery charging is complete.

According to an embodiment, the method for operating the wearable electronic device may further include stopping the reception of power from the external electronic device, when the wearable electronic device is located outside the specified distance from the external electronic device while wirelessly receiving power from the external electronic device.

According to an embodiment, the method for operating the wearable electronic device may further include driving the wearable electronic device in the charging standby mode, based on stopping the reception of power.

According to an embodiment, the method for operating the wearable electronic device may further include performing some of a plurality of charging preparatory operations for wirelessly receiving power from the external electronic device, in the charging standby mode.

According to an embodiment, an electronic device may include a battery, a power transmission circuit, a communication circuit, a processor, and memory storing instructions. According to an embodiment, the instructions, when executed by the processor, may cause the electronic device to receive power request information from a ring-shaped wearable electronic device through the communication circuit. According to an embodiment, the instructions, when executed by the processor, may cause the electronic device to, based on receiving the power request information, identify a power level of the battery and whether the electronic device is located within a specified distance from the wearable electronic device. According to an embodiment, the instructions, when executed by the processor, may cause the electronic device to, based on the power level of the battery being higher than a specified level and the electronic device being located within the specified distance from the wearable electronic device, wirelessly transmit power to the wearable electronic device through the power transmission circuit.

According to an embodiment, the instructions, when executed by the processor, may cause the electronic device to identify whether a user grips the electronic device with a hand wearing the wearable electronic device through the sensor 472 included in the electronic device. According to an embodiment, the instructions, when executed by the processor, may cause the electronic device to identify that the electronic device is located within the specified distance from the wearable electronic device, when identifying that the user grips the electronic device with the hand wearing the wearable electronic device.

According to an embodiment, the instructions, when executed by the processor, may cause the electronic device to display information related to charging of the wearable electronic device through the display 485 included in the electronic device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable electronic device having a ring-shaped body comprising:
a battery;
a power reception circuit;
a communication circuit;
memory, comprising one or more storage media, storing instructions; and
one or more processors communicatively coupled to the memory,
wherein the instructions, when executed by the one or more processors individually or collectively, cause the wearable electronic device to:
identify a power level of the battery,
based on identifying that the power level is lower than a specified level, transmit power request information to an external electronic device through the communication circuit,
based on transmitting the power request information, drive the wearable electronic device in a charging standby mode for wirelessly receiving power from the external electronic device,
based on driving the wearable electronic device in the charging standby mode, set parameters of at least one of the power reception circuit or the communication circuit to values corresponding to the charging standby mode for wirelessly receiving power from the external electronic device, and
wirelessly receive power from the external electronic device through the power reception circuit, when the wearable electronic device driven in the charging standby mode is located within a specified distance from the external electronic device.

2. The wearable electronic device of claim 1, wherein the instructions, when executed by the one or more processors individually or collectively, further cause the wearable electronic device to:
wirelessly receive power from the external electronic device through the power reception circuit, when the external electronic device is gripped by a hand of a user wearing the wearable electronic device.

3. The wearable electronic device of claim 1, wherein the instructions, when executed by the one or more processors individually or collectively, further cause the wearable electronic device to:
identify whether the wearable electronic device is worn by the user through a sensor included in the wearable electronic device, and
based on identifying that the wearable electronic device is worn by the user, identify the power level of the battery.

4. The wearable electronic device of claim 1, wherein the instructions, when executed by the one or more processors individually or collectively, further cause the wearable electronic device to:
change a driving mode of the wearable electronic device from an idle mode to the charging standby mode, based on transmitting the power request information.

5. The wearable electronic device of claim 4, wherein the instructions, when executed by the one or more processors individually or collectively, further cause the wearable electronic device to:
drive in the idle mode, when battery charging is complete.

6. The wearable electronic device of claim 1, wherein the instructions, when executed by the one or more processors individually or collectively, further cause the wearable electronic device to:
stop the reception of power from the external electronic device, when the wearable electronic device is located outside the specified distance from the external electronic device while wirelessly receiving power from the external electronic device.

7. The wearable electronic device of claim 6, wherein the instructions, when executed by the one or more processors individually or collectively, further cause the wearable electronic device to:
drive in the charging standby mode, based on stopping the reception of power.

8. The wearable electronic device of claim 1, wherein the instructions, when executed by the one or more processors individually or collectively, further cause the wearable electronic device to:
activate the power reception circuit based on the parameters, in the charging standby mode, and
perform, through the activated power reception circuit, a specified preparatory operation among a plurality of charging preparatory operations for wirelessly receiving power from the external electronic device in the charging standby mode.

9. The wearable electronic device of claim 1, wherein the instructions, when executed by the one or more processors individually or collectively, further cause the wearable electronic device to:
activate the communication circuit based on the parameters to identify a distance from the external electronic device, in the charging standby mode, and
identify, through the activated communication circuit, the distance from the external electronic device based on a signal received from the external electronic device in the charging standby mode.

10. A method for operating a wearable electronic device having a ring-shaped body, the method comprising:
identifying a power level of a battery included in the wearable electronic device;
based on identifying that the power level is lower than a specified level, transmitting power request information to an external electronic device through a communication circuit included in the wearable electronic device;
based on transmitting the power request information, driving the wearable electronic device in a charging standby mode for wirelessly receiving power from the external electronic device;
based on driving the wearable electronic device in the charging standby mode, setting parameters of at least one of a power reception circuit included in the wearable electronic device or the communication circuit to values corresponding to the charging standby mode for wirelessly receiving power from the external electronic device; and
wirelessly receiving power from the external electronic device through the power reception circuit, when the wearable electronic device driven in the charging standby mode is located within a specified distance from the external electronic device.

11. The method of claim 10, wherein the power is wirelessly received from the external electronic device through the power reception circuit when the external electronic device is gripped by a hand of a user wearing the wearable electronic device.

12. The method of claim 11, wherein the identifying of the power level of the battery includes:
identifying whether the wearable electronic device is worn by the user through a sensor included in the wearable electronic device; and
based on identifying that the wearable electronic device is worn by the user, identifying the power level of the battery.

13. The method of claim 10, wherein driving the wearable electronic device in the charging standby mode includes changing a driving mode of the wearable electronic device from an idle mode to the charging standby mode, based on transmitting the power request information.

14. The method of claim 13, further comprising:
driving the wearable electronic device in the idle mode, when battery charging is complete.

15. The method of claim 10, further comprising:
stopping the reception of power from the external electronic device, when the wearable electronic device is located outside the specified distance from the external electronic device while wirelessly receiving power from the external electronic device.

16. The method of claim 10, further comprising:
driving in the charging standby mode, based on stopping the reception of power.

17. The method of claim 10, further comprising:
activating the power reception circuit based on the parameters, in the charging standby mode, and
performing, through the activated power reception circuit, a specified preparatory operation among a plurality of charging preparatory operations for wirelessly receiving power from the external electronic device in the charging standby mode.

18. The method of claim 10, further comprising:
activating the communication circuit based on the parameters to identify a distance from the external electronic device, in the charging standby mode, and
identifying, through the activated communication circuit, the distance from the external electronic device based on a signal received from the external electronic device in the charging standby mode.

19. One or more non-transitory computer-readable storage media storing one or more computer programs including computer-executable instructions that, when executed by one or more processors of a wearable electronic device individually or collectively, cause the electronic device to perform operations, the operations comprising:
identifying a power level of a battery included in the wearable electronic device;
based on identifying that the power level is lower than a specified level, transmitting power request information to an external electronic device through a communication circuit included in the wearable electronic device;
based on transmitting the power request information, driving the wearable electronic device in a charging standby mode for wirelessly receiving power from the external electronic device;
based on driving the wearable electronic device in the charging standby mode, setting parameters of at least one of a power reception circuit included in the wearable electronic device or the communication circuit to values corresponding to the charging standby mode for wirelessly receiving power from the external electronic device; and
wirelessly receiving power from the external electronic device through the power reception circuit, when the wearable electronic device driven in the charging standby mode is located within a specified distance from the external electronic device.

20. The one or more non-transitory computer-readable storage media of claim 19, the operations further comprising:
stopping the reception of power from the external electronic device, when the wearable electronic device is located outside the specified distance from the external electronic device while wirelessly receiving power from the external electronic device.
